(19) United States
(12) Patent Application Publication
(10) Pub. No.: US 2013/0003064 A1
(43) Pub. Date: Jan. 3, 2013

(54) Dynamic Spectral Radiance Calibration Source

(75) Inventors: David W. Allen, Gaithersburg, MD (US); Steven W. Brown, Gaithersburg, MD (US); Maritoni Litorja, Rockville, MD (US)

(73) Assignee: NATIONAL INSTITUTE OF STANDARDS AND TECHNOLOGY, Gaithersburg, MD (US)

(21) Appl. No.: 13/342,552

(22) Filed: Jan. 3, 2012

Related U.S. Application Data
(60) Provisional application No. 61/429,213, filed on Jan. 3, 2011.

(51) Int. Cl. G01J 1/32; G01J 3/28; G01J 3/443; G01J 1/42

(52) U.S. Cl. 356/402; 250/228; 250/205; 250/459.1

(57) ABSTRACT

Systems and methods for measuring spectral distribution of an illumination source and providing desired output spectral radiance are described. The systems include a user defineable light source, an integrating sphere, and one or more light detectors.

### CROSS REFERENCES TO RELATED APPLICATIONS

This application claims priority from U.S. provisional application Ser. No. 61/429,213 filed on Jan. 3, 2011.

### STATEMENT AS TO RIGHTS TO INVENTION(S) MADE UNDER FEDERALLY-SPONSORED RESEARCH AND DEVELOPMENT

The US Government, through the National Institute of Standards and Testing, is the owner of this invention.

### FIELD

The present invention relates to systems and related methods for measuring spectral distribution of an illumination source and/or illuminated samples. The present invention also relates to systems and methods for providing a desired spectral radiance output.

### BACKGROUND

There are currently two dominant approaches to calibrating instruments for radiance responsivity. A first approach utilizes broadband sources, commonly known as lamp illuminated integrating sphere sources (ISSs) or lamp illuminated plaques with a source radiant flux traceable to primary melting and freezing point blackbodies. A second approach uses integrating sphere sources illuminated by broadly tunable, quasi monochromatic flux with radiance scales traceable to cryogenic radiometers through primary standard radiance and irradiance meters. While the uncertainty in the radiance of primary melting and freezing point blackbodies is less than 0.1%; the uncertainties in disseminated artifacts, lamps with plaques and lamp illuminated integrating spheres, are on the order of 0.25% or greater (coverage factor k=1). FIG. 1 shows the relative combined standard uncertainty in the spectral radiance of a lamp illuminated integrating sphere source disseminated by the National Institute of Standards and Technology (NIST). Specifically, in FIG. 1, open diamonds indicate relative standard uncertainty in the radiance of sources calibrated on NIST's Facility for Automated Spectral Calibrations (FASCAL) facility; and closed diamonds indicate relative standard uncertainty in the responsivity of detectors calibrated on the NIST Spectral Comparator Facility.

For radiance scales based on lamp illuminated integrating sphere sources, care must be taken in the maintenance of the scale because integrating sphere sources exhibit a well known spectrally dependent change in their radiance over time. An example of this change is shown in FIG. 2. Specifically, FIG. 2 illustrates temporal changes in the radiance from a lamp illuminated integrating sphere source. An analysis of a seven year time series of sphere radiance validation campaigns undertaken as part of NASA's Earth Observing System (EOS) established an uncertainty of 2% to 3% in the summarized campaigns in the spectral region between 400 nm and 900 nm. The uncertainty increased to 4% to 5% in the short wave infrared (SWIR) region between 1 μm and 2.5 μm. This is considered the state of the art uncertainty in the disseminated spectral radiance of lamp illuminated integrating sphere sources at user facilities. Restated, this provides an indication as to how well scales can be maintained by users.

Programs requiring lower uncertainty in the radiance of disseminated artifacts often use filtered detectors to monitor the radiance of the source in select spectral bands. Research continues on the development of novel sources. However, reduction in the current uncertainties of conventional spectral radiance sources disseminated by National Metrology Institutes (NMIs), like NIST, will be difficult. Uncertainties in spectral radiance from secondary calibration laboratories will be larger than NMI uncertainties. Consequently, alternative strategies must be considered to achieve and maintain radiance scales with uncertainties less than 2%.

Detectors are routinely calibrated at NMIs such as NIST for spectral radiant flux, power, or responsivity with combined standard uncertainties on the order of 0.1% through the silicon spectral range (FIG. 1). The detector based laser illuminated integrating sphere source based calibrations on the NIST facility for Spectral Irradiance and Radiance Responsivity Calibrations using Uniform Sources (SIRCUS) can achieve a radiance responsivity uncertainty (k=1) less than 0.1% over the spectral range from 380 nm to 950 nm, and on the order of 0.1% from 950 nm to 1600 nm. Both silicon and indium gallium arsenide detectors have been demonstrated to be radiometrically stable over year time frames. However, these detectors, if not spectrally filtered, can not be used to derive the spectral radiance of broadband sources because of their broad spectral response ranges. Filters introduce their own uncertainties into the measurement equation and are typically avoided for the lowest uncertainty measurements. Filter radiometers were the dominant instrument in previous Earth Observing System sphere radiance validation campaigns that achieved uncertainties in sphere radiance to the 2% to 3% level.

### SUMMARY

The difficulties and drawbacks associated with previously known systems and strategies are addressed in the present systems and method for a dynamic spectral radiance calibration source.

In one aspect, the invention provides a spectral radiance calibration source system. The system comprises a user defineable light source that emits a light output. The system also comprises an integrating sphere having (i) a hollow interior defined by a diffusely reflecting internal surface, (ii) an input, and (iii) at least one access port. The integrating sphere is configured to receive the light output of the light source. The system additionally comprises an unfiltered detector configured to receive light within the hollow interior of the integrating sphere via the access port. The detector provides a quantified measurement of the light output of the light source.

In another aspect, the invention provides a system for measuring and producing a spectral source. The system comprises an integrating sphere having (i) a hollow interior defined by a diffusely reflecting internal surface, (ii) an input, and (iii) at least one access port. The system also comprises a reference spectrometer in communication with the interior of the integrating sphere via the at least one access port. The reference spectrometer provides an output signal corresponding to observed spectra. The system also comprises electronic data processing and storage provisions. The electronic provisions receive the output signal of the reference spectrometer. The electronic provisions provide another output signal. The system also provides a user defineable light source capable of emitting a light output. The user defineable light source receives the output signal of the electronic provisions.

In another aspect, the invention provides a method for generating a specific radiance spectra. The method comprises providing a system including (i) a user defineable light source emitting a light output, (ii) an integrating sphere having a hollow interior defined by a diffusely reflecting internal surface, an input, and at least one access port, the integrating sphere configured to receive the light output of the light source, (iii) an unfiltered detector configured to receive light within the hollow interior of the integrating sphere via the access port, wherein the detector provides a quantified measurement of the light output of the light source, and (iv) a controller in communication with the light source for selectively adjusting the light output. The method also comprises identifying the specific radiance spectra. The method additionally comprises operating the system to thereby emit the light output to the integrating sphere and generating a quantified measurement of the light output. And, the method further comprises adjusting the light output of the light source by the controller so that the quantified measurement of the light output substantially matches the identified specific radiance spectra to thereby generate the specific radiance spectra.

And in another aspect, the invention provides a method for quantifying a spectral source and generating a desired radiance spectra using a common system. The system includes (i) an integrating sphere having a hollow interior defined by a diffusely reflecting internal surface, an input, and at least one access port, (ii) a reference spectrometer in communication with the interior of the integrating sphere via the at least one access port, the reference spectrometer providing an output signal corresponding to observed spectra, (iii) electronic data processing and storage provisions, the electronic provisions receiving the output signal of the reference spectrometer, the electronic provisions providing another output signal, (iv) a user defineable light source capable of emitting a light output, the user defineable light source receiving the output signal of the electronic provisions. The method comprises directing light from the spectral source into the interior of the integrating sphere. The method also comprises exposing the reference spectrometer to light within the interior of the integrating sphere from the spectral source, to thereby produce a first output signal. The first output signal is representative of the spectral source. The method also comprises providing a second output signal by use of the electronic provisions. The second output signal is based at least in part upon the first output signal. And the method additionally comprises operating the user defineable light source to thereby generate a desired radiance spectra based upon the second output signal from the electronic provisions.

As will be realized, the subject matter described herein is capable of other and different embodiments and its several details are capable of modifications in various respects, all without departing form the claimed subject matter. Accordingly, the drawings and description are to be regarded as illustrative and not restrictive.

### BRIEF DESCRIPTION OF THE DRAWINGS

FIG. 1 is a graph illustrating relative uncertainty in the radiance of certain sources, and the relative uncertainty in the responsivity of certain detectors.

FIG. 2 is a graph illustrating temporal changes in the radiance from a lamp illuminated integrating sphere source.

FIG. 3 is an image of a spectrograph entrance slit on a charge coupled device (CCD) detector.

FIG. 4 is a schematic illustration of a preferred embodiment dynamic spectral radiance calibration source.

FIG. 4A is a schematic illustration of another preferred embodiment dynamic spectral radiance calibration source.

FIG. 5 is a schematic illustration of another preferred embodiment dynamic spectral radiance calibration source.

FIG. 6 is a graph of spectral radiance of a preferred embodiment dynamic spectral radiance calibration source in broadband and narrow band modes.

FIG. 7 is a graph of wavelength calibration of a preferred embodiment dynamic spectral radiance calibration source.

FIG. 8 is a graph of changes in band center wavelength over time.

FIG. 9 is a graph of standard deviation and standard deviation of mean values for certain monochromatic bands.

FIG. 10 is a graph illustrating uncertainty in sphere radiance.

FIG. 11a is a graph of spectral distribution of a narrow band configuration at 550 nm, on a linear scale.

FIG. 11b is a graph of the spectral distribution on a logarithmic scale.

FIG. 12 is a graph of percent standard deviation in the ratio of certain tube radiometers and an internal monitor signal.

FIG. 13 is a graph illustrating changes in differences from mean radiances over time.

FIG. 14 is a graph illustrating changes in differences from mean radiances over time.

FIG. 15 is a graph comparing radiances and percentage differences of summed monochromatic light and white light.

FIGS. 16A, 16B, and 16C illustrate examples of measured, known, and produced spectra associated with a preferred embodiment system.

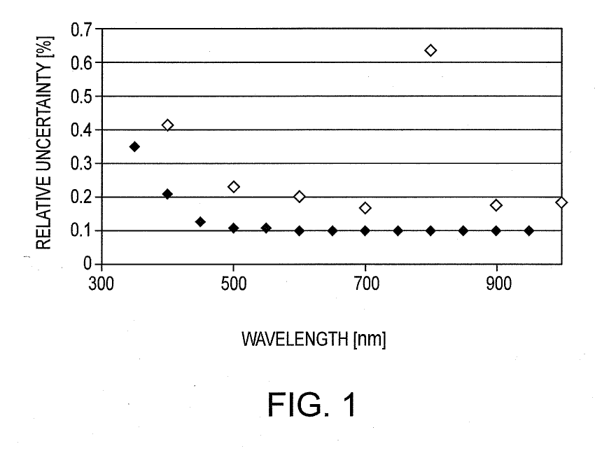

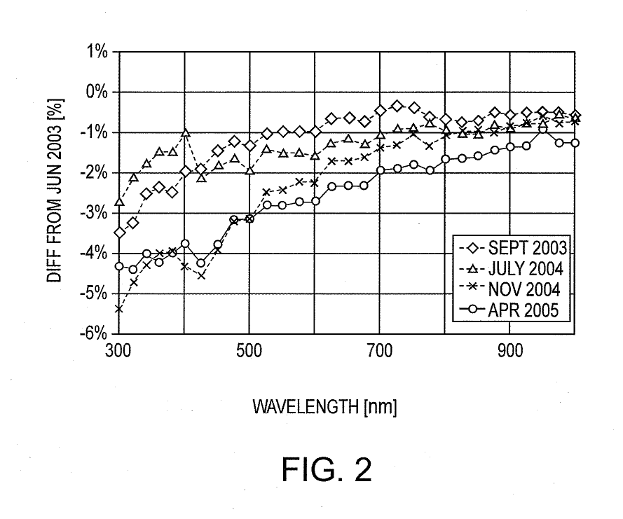

### DETAILED DESCRIPTION OF THE EMBODIMENTS

As described in greater detail herein, the present invention provides systems and methods for measuring, characterizing, and/or quantifying an illumination source. Such systems and methods provide a benchmark or reference standard for that illumination source for subsequent use in conjunction with the source. The present invention also provides systems and methods for producing radiance spectra which may correspond to particular illumination sources or spectra that is reflected or emitted from objects of interest. Such systems and methods can be used to mimic spectra from a biological sample. In a particularly preferred version of the invention, a single system is provided that (i) measures, characterizes, and/or quantifies the spectral distribution of an illumination source such as a lamp, and (ii) produces a corresponding spectral radiance of the illumination source. The spectral radiance produced by the system can also be “tuned” or selectively altered or modified as desired.

An ideal source configuration would be one that could be calibrated in narrow spectral wavelength bands using unfiltered detectors with uncertainties commensurate with detector responsivity scales, and subsequently operated in broadband mode during sensor calibrations. The preferred embodiment dynamic spectral radiance calibration source makes use of both narrow band and broadband configurations, enabling it to be calibrated with narrow spectral distributions, then operated with a broad spectral distribution for sensor characterization and calibration measurements. In a preferred embodiment, the radiometric quantity, e.g. radiance, is measured in quasi monochromatic bands with calibrated radiance meters. The same system then generates broadband flux and a Device Under Test (DUT) measures the radiant flux from the source in broadband mode. In this way, the uncertainties of detector based calibrations are achieved while the benefits of using a broadband source for sensor characterization and calibration are maintained. The DUT responsivity is traceable in the International System of Units (SI) through detector standards based on cryogenic radiometry. The source output is traceable to cryogenic radiometry standards as well. The preferred embodiment system comprises, in part, a light source, an integrating sphere, and the use of calibrated detector transfer standards. Due to the unique nature of the source, its spectral output is user definable. The detector based determination of the spectral radiance of the source accounts for long term changes in source intensity and distribution as well as changes in the throughput of the integrating sphere source due to sphere aging. If the preferred embodiment system was based on a conventional monochromator, the corollary would be to measure the spectral distribution of the source in a number of increments with the exit slit narrowed, then open the exit slit and collect all the transmitted light to provide a broadband source for calibrations.

In practice, the radiance scale can be maintained with multiple calibrated detectors. Having multiple radiance meters provides redundancy in the radiometric scale, reducing the chance of errors in the radiance scale due to a radiance meter responsivity changing between calibrations. The source itself never needs to be sent back for recalibration. With multiple transfer radiometers, a recalibration program can be easily implemented whereby each detector (or each group of detectors) can be sent back on a rotating schedule.

The source spectral distribution is user definable. Consequently, the preferred embodiment system is also envisioned as a characterization and performance validation source. In this application, standardized radiance distributions for an application are generated and measured by the DUT. Comparisons between measured and predicted responses by the sensor can help validate the performance of the sensor and elucidate sensor issues if they exist.

The preferred embodiment system provides a simple, effective means of maintaining a spectral radiance scale and resolves long standing issues of radiance drift in lamp illuminated integrating sphere sources. The conceptual framework of the source, characterization and radiance validation data, and temporal trending of the source radiance are described herein. An uncertainty analysis for the source radiance based on detector standards is also provided and described herein. Based on this analysis, uncertainties in the spectral radiance of the preferred embodiment system are on the order of 0.5% (k=1) in the silicon range.

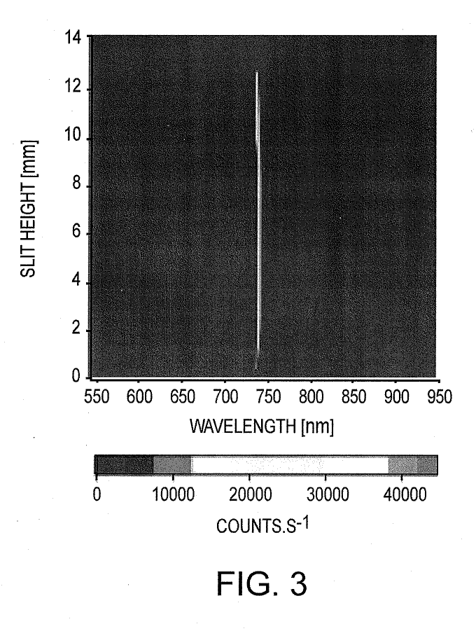

Spectrally tunable sources with user definable output, typically referred to as Spectral Light Engines, have recently been developed and are available commercially over the spectral range from 380 nm to 1600 nm. Spectral Light Engines are described in an article, N. MacKinnon, U. Stange, P. Lane, C. MacAulay and M. Quatrevalet, “Spectrally Programmable Light Engine for in Vitro or in Vivo Molecular Imaging and Spectroscopy,” Appl. Opt. 44, 2033-2040 (2005); OneLight Corporation, Vancouver, BC, Canada. Examples of commercially available Spectral Light Engines include, but are not limited to, those available from Gooch and Housego under the designation OL 490 Agile Light Source, which are described at http://www.goochandhousego.com/products/systems/spectral-imaging-synthesis/ol-490-agile-light-source, and light engines commercially available from Resonon, Inc., of Bozeman, Mont. Custom Spectral Light Engines have been developed extending the spectral coverage to 2500 nm. Additional Spectral Light Engines are under development for the 3 μm to 5 μm and 8 μm to 12 μm spectral ranges. Thus, the Spectral Light Engine provides a user selectable light output having a wavelength from about 0.1 nm to about 12,000 nm, and preferably from about 380 nm to about 1,600 nm, and in certain embodiments from about 430 nm to about 630 nm. These sources use a multi element programmable array of user selectable reflectance or transmittance elements, e.g. Digital Micromirror Device (DMD) or Liquid crystal on silicon (LCOS) arrays, in a modified double subtractive spectrometer configuration. Digital micromirror devices are also described in the previously noted paper by N. MacKinnon, et al., and are also commercially available from previously noted Gooch and Housego, and Resonon. Liquid Crystal on Silicon arrays are commercially available from Boulder Nonlinear Systems, Lafayette, Colo. Typically the entrance slit of the spectrograph is imaged at the focal plane (or the intermediate slit in a double grating spectrometer), with different spectral elements being imaged at different spatial positions on the focal plane. FIG. 3 shows the image of the entrance slit on a reference charge coupled device (CCD) detector for monochromatic light. The signal intensity is designated with the intensity given by the bar chart at the bottom of the figure. As the wavelength of the laser source changes, the image moves across the focal plane. In a preferred embodiment system, the programmable array, e.g. DMD or LCOS array, replaces the CCD at the intermediate image plane in a double subtractive spectrometer.

Consider the monochromatic laser CCD image where the CCD is replaced by a DMD. By changing the reflectance (or transmittance) of a DMD element within the column, an element can be turned ‘on’ or ‘off’. When an element is turned ‘on’, light incident on that element is transmitted through the system and collected by the exit fiber bundle. Light from elements turned ‘off’ goes into a light dump and is not transmitted through the system. By adjusting the number of elements that are turned ‘on’ within the column of elements where the imaged is formed, the intensity of the flux transmitted through the Spectral Engine at that particular wavelength can be varied. Different columns of elements project different spectral components of the incident light. Controlling all elements at the focal plane, then, results in a user definable output spectrum, limited to some degree by the spectral content of the input source and the throughput of the spectrometer.

The Spectral Light Engine can be operated in ‘monochromator-mode’ by turning on only one (or a few) columns at a time. Having identified the correlation between wavelength, or accurately slit scatter function, and array column, the resultant output radiant flux can be measured absolutely with a calibrated photodiode using Equation 1.

s(λ)[A]=L(λ)[W/(cm²·sr·nm)]R(λ)[A/(cm²·sr))]dλ(nm) (1)

R(λ) can be separated into a constant times the instrument slit scatter function (SSF):

R(λ)≡α(λ)SSF(λ) (2)

and

s(λ)[A]=α(λ)[A(W/(cm²·sr)⁻¹)]∫L(λ)[W/(cm²·sr·nm)]SSF(λ)dλ(nm) (3)

The SSF is a unit normalized, dimensionless function that describes the relative spectral content of the source at a particular wavelength setting. Identifying the instrument's SSF, measuring the output of the source as elements in each column are turned on sequentially across the array, and co-adding the measured flux, it is possible to determine the absolute spectral radiance of the integrated output of the source; that is, of a broadband source. Accordingly, a tunable radiometric source is provided in which absolute calibration of the source is traceable to detector standards that are in turn traceable via SI. The radiometric spectral radiant flux calibration can be performed internal to the Spectral Light Engine, very quickly, using a flip mirror to direct the output flux onto the calibrated detector. Alternatively, the radiometric spectral radiant flux calibration can be performed external to the source. To maintain the radiance scale of an integrating sphere source, for example, a radiance meter is used.

In a preferred embodiment system, it is preferred that the wavelength calibration of the Spectral Light Engine operated in monochromator mode remains stable, or at a minimum can be continuously monitored. To address potential wavelength drift, one solution is to integrate a wavelength standard glass into the system and periodically measure its transmittance. A second solution is to include gas filled wavelength calibration ‘pen’ lamps as a source option and periodically measure their emission lines. A wavelength standard glass is commercially available from previously noted Resonon. Gas filled wavelength calibration pen lamps are commercially available from previously noted Boulder Nonlinear Systems.

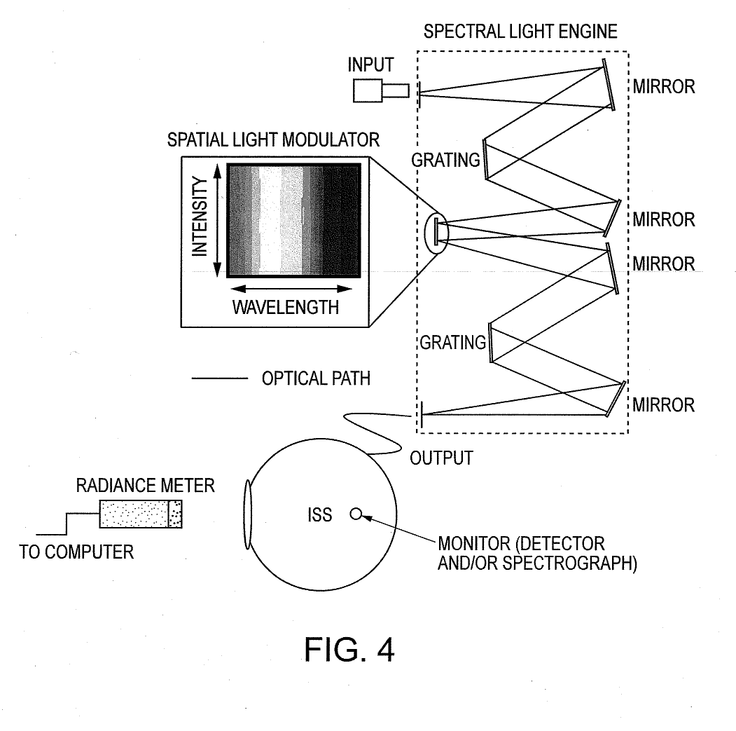

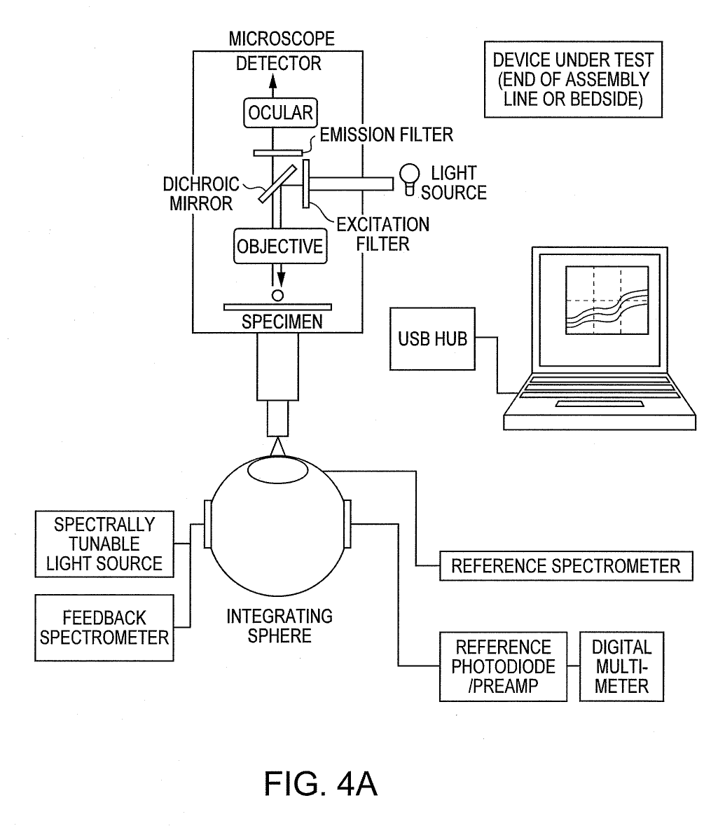

FIG. 4 is a schematic diagram of a preferred embodiment system coupled to an external integrating sphere source. The dispersing elements in the Spectral Light Engine are shown as gratings, though prisms can be used as well. Flux from the Light Engine is fiber coupled into the integrating sphere source. An internal spectrograph with its input fiber optic mounted on the sphere wall checks the wavelength calibration of the spectral engine, while the radiance meter provides an absolute calibration of the source spectral radiance. The preferred embodiment system can accept any source or combination of spectral sources in principle. The source requirements are that the system can be coupled into the Spectral Light Engine (similar to the requirements for a monochromator) and that the output of the system is stable over the course of a calibration, typically on the order of 0.5 hours. An internal spectrograph and monitor photodiode mounted on the interior wall of the integrating sphere source can account for changes in output between a calibration and subsequent measurement by the DUT.

More specifically, in a preferred embodiment, a spectral radiance calibration source system is provided. The system comprises a user defineable light source which emits a light output having user selectable properties such as wavelength and intensity or radiance. A wide range of user defineable light sources can be used. Examples of preferred user defineable light sources include commercially available Spectral Light Engines as described herein. The light sources are adjustable and emit light having a desired wavelength and/or a desired intensity.

The preferred embodiment systems also comprise an integrating sphere. An integrating sphere (also called Ulbricht sphere) is an optical device for various purposes such as measuring the optical flux from a laser diode, light-emitting diode (LED) or bulb, or measuring scattering losses from a surface. It is a hollow sphere with a diffusely reflecting internal surface, typically two or more small openings (ports) for introducing light or attaching a photodetector, and often some so-called baffles, which are light barriers used to prevent direct illumination of a detector by a light source. The arrangement causes many diffuse reflections of the introduced light before it reaches a detector, so that the light flux becomes very uniform at the detector, and nearly independent of the spatial and polarization properties of the introduced light: the detected optical power depends only on the total introduced power. In that way, the total output power of a laser diode can be measured, even if the beam divergence is fairly large.

Apart from such measurement purposes, an integrating sphere can be used to illuminate a device very uniformly. This can be important e.g. for testing the homogeneity of digital imaging equipment (e.g. CCD arrays).

Ideally, the coating on the inner side of the integrating sphere has a very high reflectivity over the required wavelength range, and the reflection is very diffuse. If the optical losses in the sphere and through the small ports are low, the multiple reflections can lead to a fairly high optical intensity inside the sphere and consequently to a high optical efficiency, even if the sphere is much larger than the light source and the detector.

A wide array of integrating spheres can be used, many of which are commercially available. The various integrating spheres described herein may additionally include the use of a defining aperture as known in the art. Furthermore, it is contemplated that instead of or in addition to an integrating sphere, an equivalent component could be used.

The preferred embodiment systems also comprise a light detector which provides a quantified measurement of a light source. Preferably, the light detector is unfiltered. The light detector can be in a variety of types and forms. A preferred light detector is a spectrograph having capabilities to measure a full array of optical parameters. The preferred light detector provides signals representative of quantified or measured optical parameters. The preferred spectrographs separate an incoming light source into a frequency spectrum.

In certain embodiments, the preferred embodiment systems also comprise a radiance detector for measuring the radiance or intensity of light within the integrating sphere.

The components of the preferred embodiment system are coupled to one another, by use of fiber optic cables and conduits. Integrating spheres are typically provided with fittings for sensors and other receivers for placement along a wall of the sphere.

The preferred embodiment system also comprises a controller to adjust or alter one or more optical parameters of the light source based upon information or signals from the light detector and/or the radiance detector. Electronic controllers are preferred such as computers with commercially available software packages such as LabView software available from National Instruments of Austin, Tex.

FIG. 4A is a schematic diagram of another preferred embodiment system. The system depicted in FIG. 4A can be used to measure, characterize and/or quantify an illumination source such as a light source which may for example be incorporated or used in a microscope or other device under test (DUT). Light from the light source of interest is directed to an integrating sphere at which a reference spectrometer measures the spectra of the light source. The reference photodiode with an optional pre-amplifier that may also be coupled with a digital multimeter can provide an SI traceable signal corresponding to the light source. Electronic processors and/or data storage provisions can be used to facilitate operation and control of the various components, i.e., the reference spectrometer, the reference photodiode, pre-amplifier, digital multimeter, and/or integrating sphere. Such electronic processors and/or data storage provisions are schematically depicted in FIG. 4A by the computer with a “USB HUB.”

The system depicted in FIG. 4A can be used to produce a radiance spectra which corresponds to an illumination source such as a light source in a device under test, or spectra reflected or emitted from objects of interest. For example, previously measured spectra such as from a light source and stored in the computer is used to operate the spectrally turnable light source shown in FIG. 4A such that the spectrally turnable light source emits the previously measured spectra in the integrating sphere. A feedback spectrometer coupled to the spectrally turnable light source and the computer can be used to selectively “tune” or modify the emitted light from the spectrally turnable light source so that the emitted spectra matches or corresponds to the previously measured spectra. The emitted light can be directed from the integrating sphere to a device under test, one or more sensors, and/or other components as desired. An example of this mode of operation of the system of FIG. 4A is producing a spectra of a previously measured or observed spectra from a biological sample. For example, a previously recorded spectra of a biological sample is stored in the illustrated computer. That data is used to generate one or more signals which are used by the spectrally turnable light source such that the spectrally turnable light source emits a radiance spectra into the integrating sphere which matches or corresponds to the previously recorded spectra of the biological sample. The emitted spectra thus “mimics” the previously observed spectra from the biological sample. Non-limiting examples of reproduced spectra include reflected spectra from tissue samples, blood or other fluid samples, and/or from non-biological samples. Additional examples of reproduced spectra include emitted spectra from fluorescing samples.

It will also be understood that the system of FIG. 4A can be used to both measure a first spectra and produce a second spectra. The produced second spectra may or may not be based upon the first spectra. Details as to the components of the system of FIG. 4 correspond to those of the components and aspects of the system in previously described FIG. 4A.

Also provided are various methods for generating specific or desired radiance spectra. Typically, such methods are performed using the systems described herein which include (i) a user defineable light source that emits a light output, (ii) an integrating sphere, (iii) a detector which is preferably unfiltered, and which provides a quantified measurement of the light output of the light source, and (iv) a controller for selectively adjusting the light output. As previously noted, the controller is preferably in the form of a computer with appropriate software as described herein. The methods also include an operation of identifying or defining the specific radiance spectra of interest. The radiance spectra of interest can be for example, spectra from another illumination source such as another instrument or medical imager. The methods also include an operation in which a light output from the light source in the system is emitted to the integrating sphere. The system and/or detector generates a quantified measurement of the light output. The methods also include an operation of adjusting the light output of the light source by use of the controller, e.g., the computer, so that the quantified measurement of the light output substantially matches the identified specific radiance spectra to thereby generate the specific radiance spectra. The term “substantially matches” as used in this regard refers to a correspondence between the spectra of at least 95%, more preferably 98%, more preferably at least 99%, and most preferably at least 99.9%.

In certain methods, when adjusting the light output of the light source based upon the identified specific radiance spectra, a comparison is performed between the identified specific radiance spectra and the quantified measurement of the light output. Furthermore, in certain versions of the preferred embodiment systems, the detector provides an output signal which is directed to the controller. The output signal from the detector conveys information indicative of the quantified measurement of the light output to the controller.

In a particularly preferred method, a system as described herein can be used to generate spectra that would be expected to correspond to a wide array of objects, items, or other specimens of interest when illuminated and/or viewed using a spectral source previously measured by the system. Generally, such methods involve directing light from the spectral source into the interior of an integrating sphere. A reference spectrometer is exposed to light within the interior of the sphere, the light being from the spectral source. A first output signal is produced such as from the reference spectrometer. The first output signal is representative of the spectral source. The method also includes then providing a second output signal such as for example by use of electronic provisions, i.e. a computer. The second output signal is based at least in part upon the first output signal. The method also includes operating a user defineable light source to generate a desired radiance spectra based upon the second output signal from the electronic provisions. The second output signal is preferably also based upon a reflectance or fluorescence signature associated with an object of interest. Using such second output signal to generate a desired radiance spectra enables a practitioner to thereby generate a desired radiance spectra that would correspond to the object of interest if illuminated or viewed using the previously measured spectral source.

It is contemplated that radiance spectra could be generated for nearly any item, object, or specimen of interest so long as their optical signature was known or provided to the preferred embodiment systems. For example, the optical signature would likely be a reflectance signature or a fluorescence signature. The item of interest could be biological or non-biological. Examples of biological items include but are not limited to tissue, blood, blood components, biological components, and like materials. Examples of non-biological items can include for example, various inorganic compounds, materials, ground or water samples, and astronomical bodies.

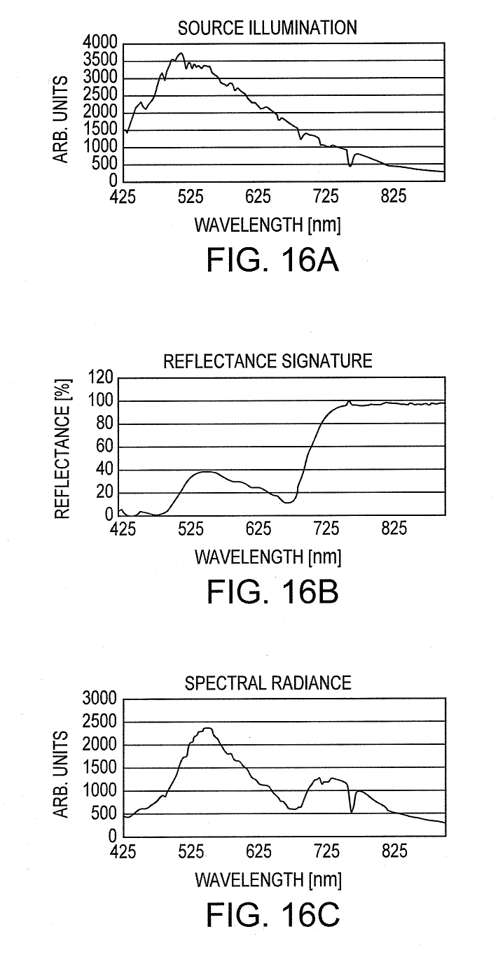

FIGS. 16A, 16B, and 16C illustrate examples of measured, known, and produced spectra associated with the preferred embodiment systems. FIG. 16A illustrates measured spectra of a user's source illumination from a device under test. This is an example of a measured input from a device under test. FIG. 16B illustrates a spectral reflectance signature of a subject of interest such as vegetation. The reflectance signature depicted in FIG. 16B is independent of the illumination source. It will be appreciated however that when illuminating the material having the reflectance signature of FIG. 16B, the observed reflectance spectra of the material will be different than the reflectance signature of FIG. 16B because the reflectance spectra is convolved with the illumination source. FIG. 16C illustrates spectral radiance produced by a preferred embodiment system. FIG. 16C is an example of a spectral radiance output produced by the preferred embodiment system. The spectral radiance output of FIG. 16C produced by the preferred embodiment system mimics the spectra that would be observed if the material associated with the reflectance signature of FIG. 16B were illuminated with the device producing the source illumination of FIG. 16A.

In simplest terms,

$$spectral reflectance = ρ ( λ ) = \frac{{S}_{reflected} ( λ )}{{S}_{incident} ( λ )}$$

where ρ(λ) is the spectral reflectance, s_{incident} is the signal from the incident light, and s_{reflected} is the signal from the light reflected off of the surface of a substance, also referred to as “spectral radiance”.

The preferred embodiment systems can produce the equivalent spectral radiance, s_{reflected}(λ), as depicted in FIG. 16C, by measuring s_{incident}(λ), as shown in FIG. 16A, from the device under test and multiplying it by ρ(λ), e.g. FIG. 16B, a known spectral reflectance of a material.

### EXAMPLES

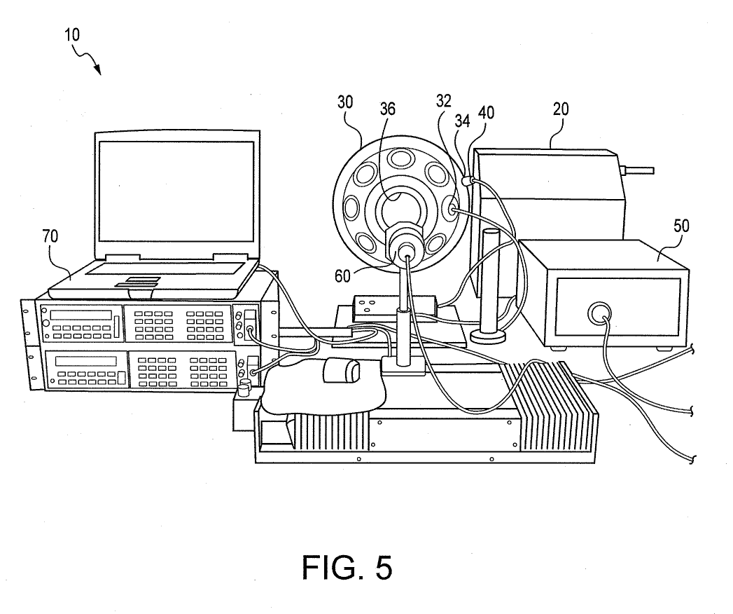

FIG. 5 is a schematic illustration of a preferred embodiment dynamic spectral radiance calibration source system 10. A OneLight Spectral Light Engine 20 with a spectral range from 430 nm to 630 nm is used as the spectrally tunable light source. The light engine 20 is illuminated by an internal Xe arc lamp. The scale is realized using three silicon Gershun-tube radiometers calibrated for spectral radiance responsivity on the NIST SIRCUS facility over the spectral range from 380 nm to 950 nm. The system 10 also comprises an integrating sphere 30 having an input 32, and at least one access port 34 which preferably includes a port 36 for radiance assessment. The system 10 additionally comprises an internal monitor silicon detector 40 and an internal monitor spectrograph 50 with its fiber optic input mounted on the wall of the sphere 30. The monitor spectrograph 50 is an Instrument Systems Vis-NIR CAS 140CT-153 compact spectrograph. The monitor spectrograph 50 has a spectral resolution of 3 nm and a spectral range from 380 nm to 1040 nm. A second external CAS instrument 60, with a radiance scale tied to NIST's Facility for Automated Spectral Calibrations (FASCAL) facility, periodically measures the spectral radiance within the sphere 30 through the port 36. This facility is described in J. H. Walker, R. D. Saunders, and A. T. Hattenburg, “Spectral Radiance Calibrations,” Natl. Bur. Stand. (U.S.) Spec Publ 250-1, U.S. Government Printing Office, Washington, D.C., 1987, 68 pages. The second instrument 60 is used as the primary standard reference instrument to validate the concept behind the preferred embodiment system 10. The external CAS instrument 60 routinely measures the radiance of calibrated lamp illuminated integrating sphere sources. The CAS responsivity has been demonstrated to be stable to better than 0.5% over the time period of a year. LabView software and computer 70 controls the output of the Spectral Light Engine 20, records the radiance meter calibration signals, and records the monitor spectrograph signals.

### Measurement Results

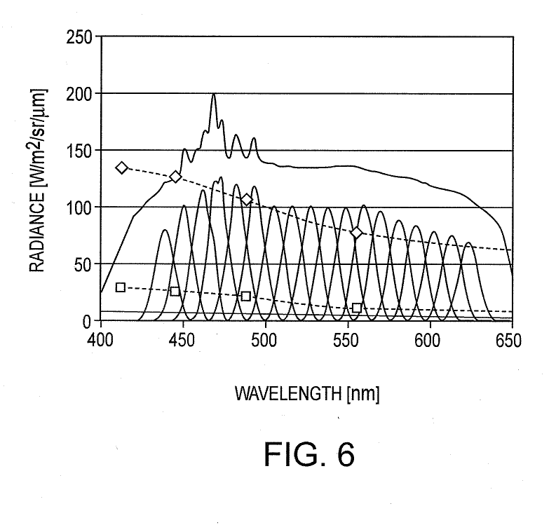

The maximum absolute spectral radiance of the preferred embodiment system, i.e. all Spectral Light Engine mirrors ‘on’ is given in FIG. 6 along with the measured radiance in narrow band or ‘monochromator’ mode, measured with the external CAS instrument. Specifically, FIG. 6 illustrates in solid lines spectral radiance of the preferred system in broadband and narrow band modes. The dashed lines in FIG. 6 extending between diamonds, corresponds to maximum top of the atmosphere radiance from an ocean scene, and the dashed lines extending between solid squares, corresponds to minimum top of the atmosphere radiance from an ocean scene. In narrow band mode, the spectrum is split into 20 components, with each ‘band’ 50 columns wide. Also shown in the figure are minimum and maximum expected top of atmosphere (TOA) radiances on-orbit from an ocean scene. The maximum radiance from the preferred embodiment system compares well with expected top of atmosphere water leaving radiances viewed by a satellite sensor, with the preferred embodiment system maximum radiance being larger than the maximum top of the atmosphere water leaving radiance above 440 nm.

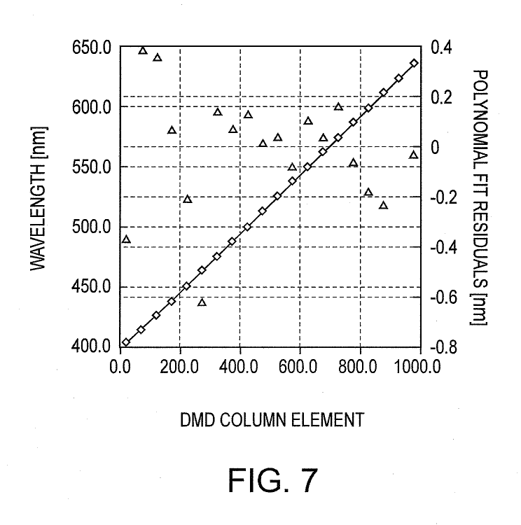

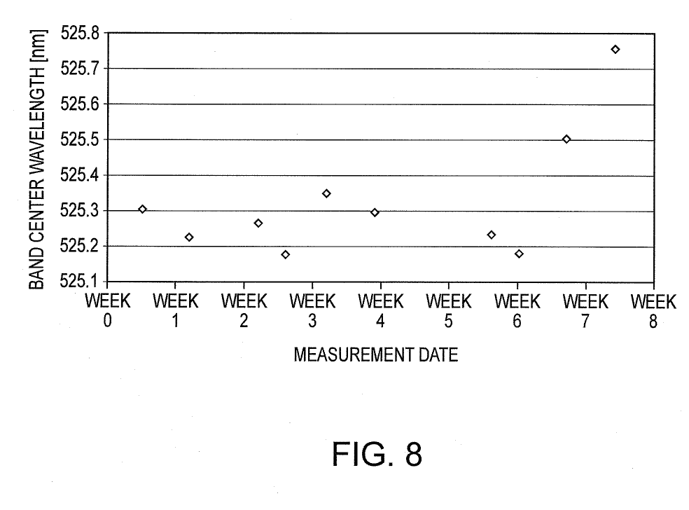

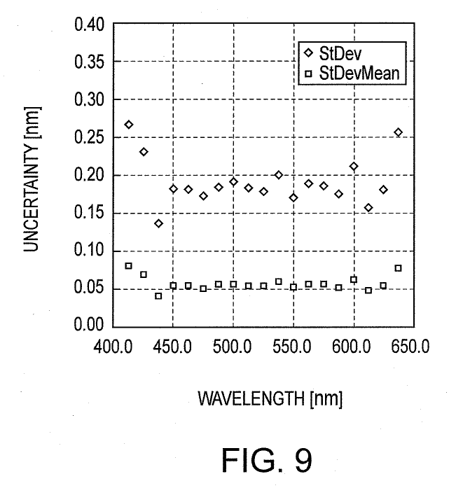

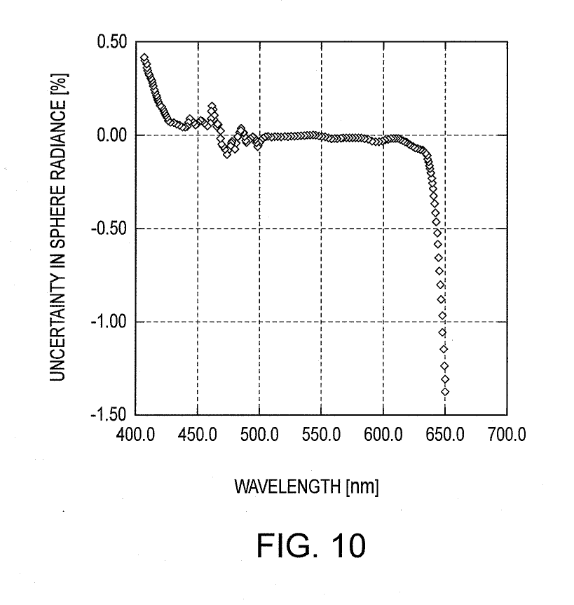

The narrow band data can be used for a wavelength calibration of the preferred system. FIG. 7 shows the peak wavelength as a function of DMD column element. Specifically, FIG. 7 illustrates wavelength calibration of the preferred embodiment system, in which diamonds are the data, the solid line is a 4^{th} order polynomial fit to the data, and the solid triangles are the residuals from the fit. The mean fit residual was 0 and the standard deviation of the residuals was 0.24 nm. A linear fit to the wavelength data gave a standard deviation of 0.57 nm. Over the course of a series of measurements, over a time period of approximately ten (10) weeks, the lineshape did not change, but the band center wavelength was not constant. FIG. 8 shows the time series measurement of the 525 nm band center wavelength. Specifically, FIG. 8 illustrates a temporal trend of the band center wavelength at a nominal band center wavelength of 525 nm. The band center was constant for the first 2 months of the measurements, changing a total of 0.6 nm over the last two weeks of measurements. The standard deviation and the standard deviation of the mean of the 10 measurements are shown in FIG. 9 for each of the 22 quasi monochromatic bands. Specifically, FIG. 9 illustrates standard deviation and standard deviation of the mean in the time series measurements of the band center wavelength. Uncorrected, a 0.2 nm wavelength uncertainty translates into an uncertainty in the spectral radiance at the two edges of the spectral region (400 nm and 650 nm) of approximately 2%, a 1% uncertainty near the spectral features around 450 to 500 nm, and negligibly elsewhere. Corrected, the residual uncertainty in the band center wavelength is 0.05 nm. The impact of a 0.05 nm uncertainty in the wavelength scale on the uncertainty in the sphere radiance in narrow band mode is shown in FIG. 10. Specifically, FIG. 10 illustrates uncertainty in the sphere radiance for a 0.05 nm uncertainty in band center wavelength. The uncertainty in the sphere radiance at both edges of the spectrum increases rapidly, to 0.4% at 410 nm and approximately 1% at 650 nm. For a preferred embodiment system using this Spectral Engine, an in situ wavelength calibration strategy is a requirement if low uncertainty in the radiance scale is to be maintained.

The measured signal is the integral product of the source radiance and the system responsivity. The spectral purity of the narrow band radiance is an important consideration when evaluating the full potential of the preferred embodiment system. Current commercially available Spectral Engines are single DMD, including the Spectral Engine in the preferred embodiment system 10. Using single DMD systems as opposed to double DMD systems impacts the spectral purity of the quasi monochromatic source distributions. Corrections for improperly imaged radiation can be made, see for example the stray light correction algorithm developed by Zong et al. This algorithm is described in NIST Standard Reference Materials, available at https://rproxy.nist.gov/srmors/viewTableH.cfm?tableid=118. A double element Light Engine has been proposed to improve the effective slit scatter function of Light Engines, but is not yet commercially available. See, “Achieving Satellite Instrument Calibration for Climate Change (ASIC3),” G. Ohring, ed. (2008), http://www.orbit.nesdis.noaa.gov/star/documents/ASIC3-071218-webversfinal.pdf.

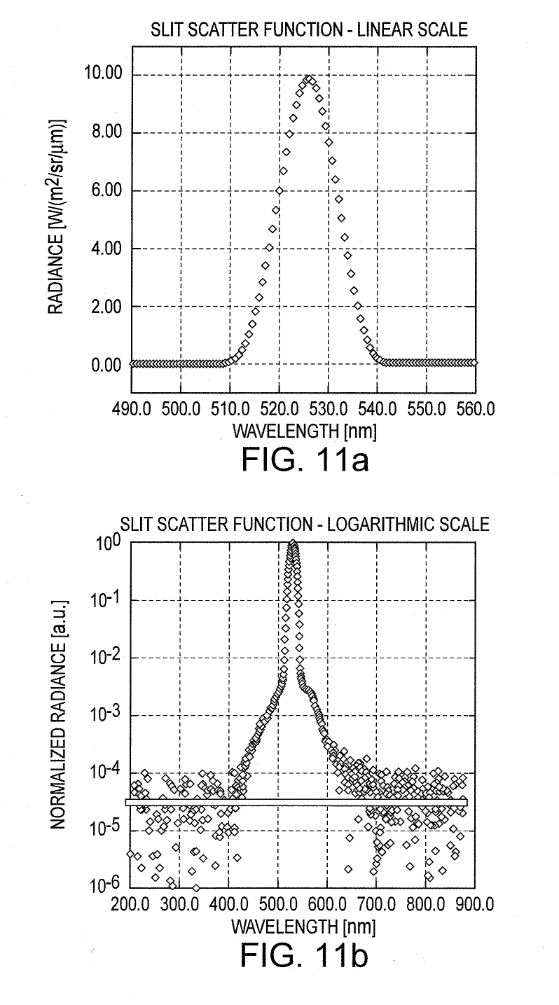

The spectral distribution of the narrow band configuration for the preferred embodiment system, analogous to a spectrometer slit scatter function, is shown on a linear scale in FIG. 11a and a logarithmic scale in FIG. 11b. Specifically, these figures illustrate spectral distribution of the narrow band configuration of the preferred embodiment system at 550 nm. The solid horizontal line in FIG. 11b corresponds to the 1 DN signal level. In addition to the strong central peak from 510 nm to 540 nm, there is a slightly asymmetric bowler hat distribution extending 150 nm on either side of the central peak with a relative magnitude ranging from 3×10⁻³ near the main peak decreasing to 5×10⁻⁴ 100 nm away. The flat distribution at the 5×10⁻⁵ level is a reflection of the dynamic range of the spectrometer used to record the spectral distribution. Also shown in FIG. 11b is the 1 Digital Number (DN), given by the solid horizontal line. The total out of band to in band signal ratio, with the in band to out of band transition at 0.01 is 0.03. That is, approximately 3% of the total measured signal arises from stray or scattered light more than 15 nm away from the peak.

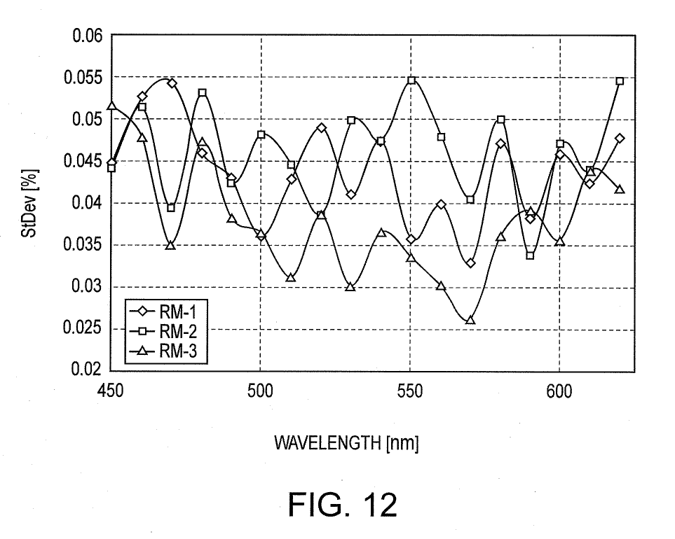

The goal of the proof of concept investigation is to verify that the radiance scale is properly held by reference single element, Si, Gershun-tube radiometers and that any changes in the spectral radiance of the source, as determined by the external CAS measurements, are properly identified by the reference Si instruments. Three Gershun-tube radiance meters (RMs), RM1, RM2, and RM3, were fabricated using a Hamamatsu S-1337 photodiode with two precision apertures held at fixed positions in two inch Thor Labs tubing. A larger aperture was placed between the two field of view limiting apertures to serve as a baffle in the system. The three radiance meters were calibrated on the NIST facility for Spectral Irradiance and Radiance Responsivity Calibrations using Uniform Sources (SIRCUS). Their radiance responsivities are shown in FIG. 12. Specifically, FIG. 12 illustrates the percent standard deviation in the ratio between the Gershun tube radiometers and the internal Si monitor signal.

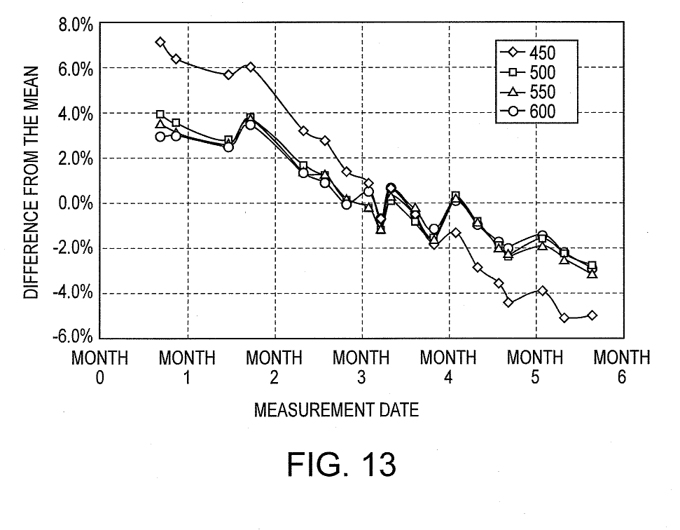

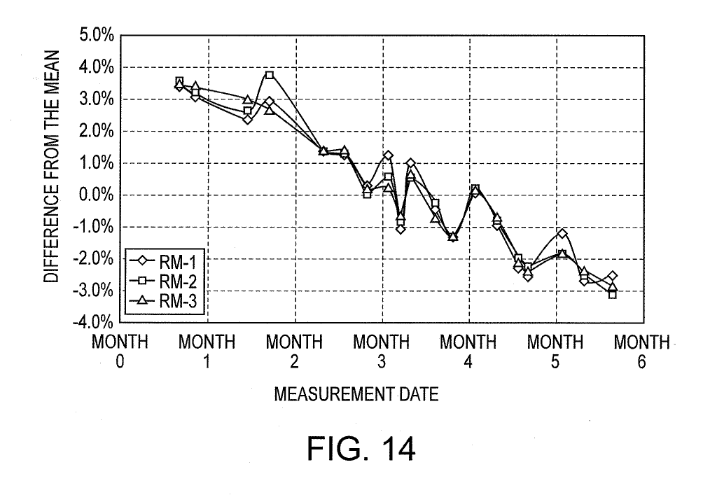

The radiance of the source was measured routinely by the three radiance meters, the Si monitor photodiode and the external CAS spectroradiometer over the course of three months. The percent standard deviation in the ratio between the Gershun tube radiometers and the internal Si monitor signal is shown in FIG. 12 This provides a measure of the repeatability of the measurements. The uncertainty in the measurement repeatability is approximately 0.045%, independent of which reference radiometer is used. FIG. 13 shows the difference from the mean radiance measured by RM-2 over the course of 5 months at approximate center wavelengths of 450 nm, 500 nm, 550 nm, and 600 nm. All three radiance meters show the same trends: a decrease of approximately 12% at 450 nm, 7% at 500 nm, 6% at 550 nm and 6% at 600 nm. FIG. 14 shows the results of measurements by all three radiance meters over the same 5 months at 550 nm. The decrease in measured signal could arise from lamp aging, changes in the throughput of the integrating sphere source, or a combination of both effects. From these measurements alone, it is not possible to distinguish between the possible causes of the change in sphere radiance. What is important is that changes in the integrating sphere source radiance are properly accounted for by the RMs.

The broadband signal from the RMs was compared with the summed narrow band signals. The two measurements agreed to within 0.5%, with the broadband measurements slightly higher than the narrow band measurements. The narrow band measurements excluded the final 24 pixels in the DMD array, resulting in a 0.3% bias to the measurements. Including the final 24 pixels in the narrow band measurement, the discrepancy is reduced to 0.2%. Note that these evaluations do not include any monitor signal information in this comparison so source drift is not accounted for in this measurement.

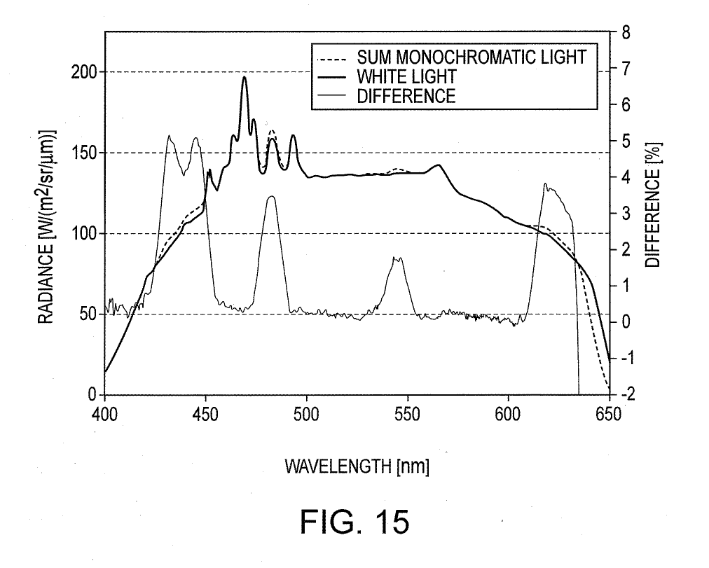

Finally, the integrated narrow band signal measured by the external CAS is compared to the broadband ‘white light’ signal. For the integrated narrow band radiance, the narrow band spectral distributions shown in FIG. 6 are integrated or summed. FIG. 15 shows a typical integrated narrow band measurement and the corollary broadband measurement. Specifically, FIG. 15 is a comparison of the external CAS measurements (dashed line) summed quasi monochromatic light; (solid line) white light (all mirrors on) radiance; and (grey line) the difference between the two measurements. The agreement is fairly good in several spectral windows, with agreement between the two measurements at the 0.2% level. There are regions of disagreement at the 1% to 5% level, with the exception of the long wavelength edge of the spectral distribution, near 650 nm (not shown in the graph). The larger disagreement in this area is due to the fact that not all mirrors were turned on for the quasi monochromatic measurements. Note that these data were not normalized by the internal spectroradiometer and do not account for potential source drift during the measurements.

### Uncertainty Estimate

The principal uncertainty components are listed in Table 1, set forth below. The individual components were considered to be uncorrelated and the root sum square of the components were taken for the combined standard uncertainty at each wavelength. The short term stability is given by the percent standard deviation of the measurements at a given wavelength (FIG. 12). There is little discernable spectral dependence to the measured standard deviation in the measurements, nor is there a radiance meter dependence. A spectrally invariant uncertainty of 0.045% was chosen for this component.

Considering the corrected long term trending of the radiance, the trending data from FIG. 14 was fitted to a 3^{rd} order polynomial. The standard deviation of the fit residual of 0.5% was approximately the same for each Radiance Meter. However, the data are strongly correlated. Taking the mean difference between the three Radiance Meter measurements over the time scale of the measurements gives an uncertainty of 0.12%. This number is used as an estimate of the uncertainty in the long term trending of the preferred embodiment system.

There is a residual uncertainty of 0.05 nm in the wavelength calibration (FIG. 9). FIG. 10 shows the uncertainty in the sphere radiance for a 0.05 nm wavelength uncertainty. The uncertainty from the graph is included in Table 1, as follows.

TABLE 1
Uncertainty Components Associated with the Preferred Embodiment System

| | Magnitude [%] | | | | |
|---|---|---|---|---|---|
| Uncertainty Component | 400 nm | 450 nm | 500 nm | 550 nm | 600 nm |
| Short term repeatability | 0.045 | 0.045 | 0.045 | 0.045 | 0.045 |
| Long term stability (corrected) | 0.12 | 0.12 | 0.12 | 0.12 | 0.12 |
| Wavelength Calibration | 0.4 | 0.15 | 0.05 | 0.01 | 0.02 |
| Radiance meter calibration | 0.2 | 0.15 | 0.1 | 0.1 | 0.1 |
| Narrow band to Broadband | 0.3 | 0.3 | 0.3 | 0.3 | 0.3 |
| algorithm | | | | | |
| RM-based Combined Standard | 0.554 | 0.389 | 0.345 | 0.341 | 0.342 |
| Uncertainty in sphere radiance [%] | | | | | |
| Reference Spectroradiometer | 2 | 2 | 2 | 2 | 2 |
| Calibration Uncertainty [%] | | | | | |
| Combined Standard Uncertainty | 2.075 | 2.038 | 2.030 | 2.029 | 2.029 |
| in RM & CAS sphere radiance | | | | | |
| comparison [%] | | | | | |

The uncertainty in the Radiance Meter calibrations, including interpolation between calibration points and long term stability of the meters, is approximately 0.2% at 400 nm, decreasing to 0.1% beyond 500 nm. An uncertainty of 0.3% was assigned for the uncertainty in the scale transfer from the quasi monochromatic, narrow band distribution to a broadband distribution. The combined standard uncertainty in the SpIS radiance is given in percent in line 6 in the table, RM-based Combined Standard Uncertainty in Sphere Radiance. The external spectroradiometer calibration uncertainty, 2.0%, is included for reference. The final line in the table shows the combined standard uncertainty between the preferred embodiment system and the CAS.

The current uncertainty in the narrow band to broadband algorithm is approximately 0.3%. Refining the narrow band to broadband algorithm, it is believed possible to reduce its uncertainty to 0.1%. The radiance meter calibration can have uncertainties as low as 0.05%, and a group policy (using more than one RM to hold the scale) could enable the uncertainty in the RM measurements of the sphere output to be reduced to the 0.1% level (including long term drift). Combined with an improved wavelength calibration (uncertainty of 0.02 nm), gives a combined standard uncertainty of 0.27% at 400 nm, decreasing to 0.19% beyond 500 nm. This is the realistic target uncertainty for the spectral radiance from the preferred embodiment dynamic spectral radiance calibration source. A more stable, more smoothly varying source (replacing the Xe arc lamp with a source that has less structure in the spectral radiance) may reduce the uncertainty in the detector based source radiance slightly.

### Discussion

A Light Engine can be designed to have high spectral resolution. In that case, high fidelity matches to spectrally complex spectra are possible. For example, FIG. 5 shows a spectral matching example using a spectral engine with approximately 2 nm resolution. Note the extremely good matching to ASTM AM1.5, a solar spectral distribution with narrow and complex spectral features.

As part of the Sensor Intercomparison and Merger for Biological and Interdisciplinary Oceanic Studies (SIMBIOS) Project, a lamp illuminated integrating sphere source, the SeaWiFS Quality Monitor (SQM), was measured by participating organizations as a quality assurance of the radiometric scales maintained by participating organizations. The radiance of the SQM was validated by the SeaWiFS Transfer Radiometer (SXR), a multi band filter radiometer. In this campaign, the spectral distribution of the source was fixed—approximating a blackbody distribution around 2800 K, and the uncertainty in the transfer radiometer was approximately 2%. This study, while valuable, was limited spectrally in its ability to approximate the distributions that participating instruments might see as well as radiometrically in the uncertainty achievable. The participating instruments measured up welling or water leaving radiance. One example application might be to use the preferred embodiment system as an advanced SQM. Modeled distributions for different water column optical properties can be generated by the preferred system and measured by the DUT. The uncertainty in the sphere radiance should be 0.5% or lower, significantly lower than uncertainties achieved during previous campaigns using the SQM. Differences between predicted and measured radiance distributions by the DUT will validate, or set limits, on its radiometric performance.

### SUMMARY AND CONCLUSIONS

Results from a time series of measurements of the preferred embodiment system source radiance were presented. The reference radiance meter RM2 measured a change in the radiance of the integrating sphere source of approximately 10% at 550 nm. Over the same time period, the radiance meter to internal silicon monitor photodiode ratio remained essentially constant. These results indicate that the external radiance meters can account for changes in the sphere throughput as well as changes in the source spectral output, two of the dominant sources of uncertainty in lamp illuminated integrating sphere source radiance scales. The uncertainty in the radiance of the preferred embodiment system source is on the order of 0.55% or less, with a slight spectral dependence. With additional effort, in particular improving the RM narrow band to broadband conversion, the uncertainty in the radiance scale can potentially be reduced to the 0.2% level (k=1). This uncertainty is slightly larger than the uncertainty in the responsivity of Si detector standards and is commensurate with the uncertainty in the NIST radiance scale. However, it is significantly lower than the uncertainty in the disseminated scale determined by NASA's Earth Observing System's validation campaign.

It is worthwhile repeating that any source that can be coupled into a spectrometer is suitable as the preferred embodiment system source. Anticipated developments in the preferred embodiment system include extending the spectral coverage over the full silicon range and replacing the Xe arc source with more stable sources. Light Emitting Diodes (LEDs) and Quartz Tungsten Halogen (QTH) lamps are both radiometrically stable in the short term at the 0.1% level or better. High power LEDs provide good coverage through the visible region, but become sparse below 440 nm in the blue and above 700 nm in the NIR. QTH lamps provide maximum flux around 1000 nm, with the flux decreasing through the visible region. A combination of LEDs and QTH lamps could potentially be used as a replacement source for the Xe arc lamp in the preferred embodiment system with an extended spectral range, from 380 nm to 1000 nm.

### ADDITIONAL APPLICATIONS

The preferred embodiment systems provide spectral radiance corresponding to the spectral reflectance of a given substance with respect to the spectral distribution of the illumination source of the sensor or device under test.

The various systems and methods described herein can provide a corresponding output for reflectance or fluorescence where the fluorescence emission is either static or variable with time, i.e. emission decay.

Several examples of possible applications are provided but the use is not limited to these applications as such use could be used in any application where a spectral sensor or spectral imager needs to be characterized.

### Example 1

### Oximetric Imaging of Human Tissue

A preferred embodiment system can be used for characterizing and/or providing a chemometric scale for oxyhemoglobin (HbO2). The sensor under test would illuminate the integrating sphere, in place of human tissue, use the spectral distribution of the illumination source convolved with a known spectral reflectance signature for a given HbO2 tissue concentration and output a corresponding spectral radiance, as an equivalent to the reflected light from human tissue. A series of such steps can be repeated with variable HbO2 concentrations to provide a chemometric scale. This allows a reproducible substitution of the tissue with a known spectral radiance level. The substitution of the tissue with the preferred embodiment system can be referred to as a Digital Tissue Phantom.

### Example 2

### Epifluorescence Microscope Characterization

An epifluorescence microscope would have the integrating sphere (or equivalent) inserted where the microscope slide would be mounted. The excitation source from the microscope would be measured for intensity and spectral distribution. The measured source spectral distribution is used to produce a corresponding emission spectrum for a given substance, i.e. green fluorescent protein. The output emission spectrum can either be static or change as a function of time in order to mimic a decaying emission. The preferred embodiment system, in this application, substitutes either a slide specimen or a physical calibration artifact.

### Example 3

### Ocean Color Sensor Characterization

A sensor used to measure the ocean color (or any spectral sensor ranging from a portable spectrometer to a satellite sensor) can be considered as a sensor under test. The preferred embodiment system would be used to measure the solar spectral irradiance. The measured solar spectral irradiance would be used with a known chlorophyll concentration representative of an open body of water to produce a corresponding water leaving radiance as the output of the preferred embodiment system. This process can be repeated for various chlorophyll concentrations in order to validate the range of the sensor under test.

The preferred embodiment system is an absolutely calibrated, spectrally tunable detector based source of spectral radiance. A detector based radiance scale is simpler to maintain and offers the possibility of reduced uncertainties in the spectral radiance of the integrating sphere sources with broad spectral distributions over conventional source based radiance scales. The preferred embodiment system has the potential to achieve uncertainties in the spectral radiance required for sources used to calibrate satellite remote sensing climate change sensors looking at reflected solar radiation. An additional application of the preferred embodiment system may include round robin quality assurance campaigns to validate the performance of instruments that measure different spectral distributions.

The various systems, methods, and strategies described herein will find wide application in an array of fields and technologies. For example, application in imaging such as medical imaging of cells, tissue, or other biological matter is envisioned. The systems and methods can be used to disseminate spectral signatures for chemometric scales using reference standards obtained from the systems described herein. For example, the systems described herein can measure a user's illumination source and provide a reference or quantified spectrum of that illumination source. Alternatively, unknown spectral signatures can be analyzed using the systems described herein. Furthermore, instrument responsivity can be analyzed using the systems and methods described herein. The systems can be used to calibrate a wide range of instruments such as microscopy equipment, microscopes, field imagers, endoscopes, multispectral imagers, hyperspectral imagers, and nearly any instrument with an illumination source that uses light for analysis. In general, the systems provide an SI traceable scale of radiance of variable spectral distributions. The spectra can be any spectra of interest and can be narrow band, broad band, and multi-band distributions. The systems, once calibrated or otherwise configured can maintain the scale of radiance and measure the irradiance of sources. The spectra produced can be those which are of interest and not limited by the lamp spectral distribution. Non-limiting examples of such spectra include spectra of blood, solar irradiance, vegetation, green fluorescent protein, etc. Furthermore, the systems can be used for spatial or spectral characterization of an imager or other device or instrument.

The systems and/or methods provided herein will find wide application in numerous fields and applications. For example, the systems can provide standards for reflected spectra and emitted spectra from a wide range of specimens and objects, and/or using a wide array of illumination sources. Specifically for example, a reference spectra can be readily produced which may not otherwise occur or exist in nature. Also, for example, a reference spectra can be produced which is identical or substantially identical to an object or specimen for which no corresponding standard is currently available. Color tiles used as reference spectra indicators in medical imaging are notoriously inaccurate. Furthermore, the systems and/or methods provided herein can be implemented in large scale systems such as in satellites observing and analyzing spectra from oceans in which surface areas of interest are typically on the order of kilometers; and in small scale systems used in medical imaging in which surface areas of interest are typically on the order of millimeters or centimeters.

Many other benefits will no doubt become apparent from future application and development of this technology.

All patents, published applications, standards, and articles noted herein are hereby incorporated by reference in their entirety.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. A spectral radiance calibration source system, the system comprising:
a user defineable light source emitting a light output;
an integrating sphere having (i) a hollow interior defined by a diffusely reflecting internal surface; (ii) an input; and (iii) at least one access port, the integrating sphere configured to receive the light output of the light source; and
an unfiltered detector configured to receive light within the hollow interior of the integrating sphere via the access port, wherein the detector provides a quantified measurement of the light output of the light source.

2. The system of claim 1 wherein the light source is a spectral light engine.

3. The system of claim 2 wherein the spectral light engine provides a user selectable light output having a wavelength from about 0.1 nm to about 12,000 nm.

4. The system of claim 3 wherein the wavelength is from about 380 nm to about 1,600 nm.

5. The system of claim 4 wherein the wavelength is from about 430 nm to about 630 nm.

6. The system of claim 1 further comprising:
a radiance detector configured to receive light within the hollow interior of the integrating sphere via another access port, wherein the radiance detector provides a measurement of the radiance of the light output of the light source.

7. A system for measuring and producing a spectral source, the system comprising:
an integrating sphere having (i) a hollow interior defined by a diffusely reflecting internal surface; (ii) an input, and (iii) at least one access port;
a reference spectrometer in communication with the interior of the integrating sphere via the at least one access port, the reference spectrometer providing an output signal corresponding to observed spectra;
electronic data processing and storage provisions, the electronic provisions receiving the output signal of the reference spectrometer, the electronic provisions providing another output signal;
a user defineable light source capable of emitting a light output, the user defineable light source receiving the output signal of the electronic provisions.

8. The system of claim 7 further comprising:
an unfiltered detector configured to receive light within the hollow interior of the integrating sphere via the at least one access port, wherein the detector provides a quantified measurement of light within the interior of the integrating sphere.

9. The system of claim 7 wherein upon directing an external light source into the interior of the integrating sphere, the reference spectrometer provides a first output signal corresponding to the spectra of the external light.

10. The system of claim 9 wherein the electronic provisions receive the first output signal from the reference spectrometer and produce a second output signal.

11. The system of claim 10 wherein the user defineable light source receives the second output signal and emits a light output corresponding to the second output signal.

12. A method for generating a specific radiance spectra, the method comprising:
providing a system including (i) a user defineable light source emitting a light output, (ii) an integrating sphere having a hollow interior defined by a diffusely reflecting internal surface, an input, and at least one access port, the integrating sphere configured to receive the light output of the light source, (iii) an unfiltered detector configured to receive light within the hollow interior of the integrating sphere via the access port, wherein the detector provides a quantified measurement of the light output of the light source, and (iv) a controller in communication with the light source for selectively adjusting the light output;
identifying the specific radiance spectra;
operating the system to thereby emit the light output to the integrating sphere and generating a quantified measurement of the light output;
adjusting the light output of the light source by the controller so that the quantified measurement of the light output substantially matches the identified specific radiance spectra to thereby generate the specific radiance spectra.

13. The method of claim 12 wherein the adjusting operation includes comparing the identified specific radiance spectra to the quantified measurement of the light output.

14. The method of claim 12 wherein the detector provides an output signal, the method further comprising:
providing the output signal from the detector which is indicative of the quantified measurement of the light output, to the controller.

15. A method for quantifying a spectral source and generating a desired radiance spectra using a common system, the system including (i) an integrating sphere having a hollow interior defined by a diffusely reflecting internal surface, an input, and at least one access port, (ii) a reference spectrometer in communication with the interior of the integrating sphere via the at least one access port, the reference spectrometer providing an output signal corresponding to observed spectra, (iii) electronic data processing and storage provisions, the electronic provisions receiving the output signal of the reference spectrometer, the electronic provisions providing another output signal, (iv) a user defineable light source capable of emitting a light output, the user defineable light source receiving the output signal of the electronic provisions, the method comprising:
directing light from the spectral source into the interior of the integrating sphere;
exposing the reference spectrometer to light within the interior of the integrating sphere from the spectral source, to thereby produce a first output signal representative of the spectral source;
providing a second output signal by use of the electronic provisions, the second output signal based at least in part upon the first output signal;
operating the user defineable light source to thereby generate a desired radiance spectra based upon the second output signal from the electronic provisions.

16. The method of claim 15 further comprising:
providing a reflectance or fluorescence signature associated with an object of interest;
wherein the second output signal is based upon both the first output signal and the provided signature.

17. The method of claim 16 wherein the signature is a reflectance signature from biological matter.

18. The method of claim 16 wherein the signature is a fluorescence signature.
